(19) United States
(12) Patent Application Publication
(10) Pub. No.: US 2003/0213275 A1
(43) Pub. Date: Nov. 20, 2003

(54) Foliar treatment

(76) Inventor: John J. Walls, LaGrande, OR (US)

Correspondence Address: Patsy R. Frye, Offices of Robert L. Harrington, Suite 1920, 1211 S.W. Fifth Avenue, Portland, OR, 97204-3713, US

(21) Appl. No.: 10/150,161

(22) Filed: May 16, 2002

(51) Int. Cl. C05F 1/00

(52) U.S. Cl. 71/16

(57) ABSTRACT

A method of producing a foliar applied fertilizer which promotes plant and tree growth and health. Fish and fish offal are processed by being reduced to a aqueous suspension. The protein parts of the suspension are hydrolyzed by enzymes and the urge remaining parts are removed by screening. The remaining suspension is concentrated by removing excess water and further stabilized. Diatomite is added as a nutrient supplement and as a source for pest control.

### FIELD OF THE INVENTION

This invention relates to the treatment of foliage by spraying the leaves of the foliage with a liquid fertilizer of hydrolyzed offal and diatomite.

### BACKGROUND AND SUMMARY OF INVENTION

A spray on foliar fertilizer of hydrolyzed fish offal is known to provide desirable nutrients to foliage such as plants, fruit bearing trees and the like. (See U.S. Pat. Nos. 4,043,788 and 4,383,845). The leaves absorb the fertilizer and the nutrients are transmitted throughout the foliage. Whereas the fertilizer provides desirable quantities of nitrogen, phosphorous and potassium, it has been determined that a truly healthy plant life requires many other minerals although in far smaller amounts. Diatomaceous earth contains as many as 65-70 different minerals in micro amounts. However, diatomaceous earth has never before been considered as a foliar treatment and does not function as a foliage treatment. Diatomite is a fine powder form of diatomaceous earthy but it is nevertheless a solid and it is not absorbed by leaves.

The present invention uses the hydrolyzed fish offal fertilizer as a carrier for the diatomite. The diatomite is suspended in the liquid fertilizer and the minerals of the diatomite are absorbed into the leaves with the nutrients of the fertilizer. A further benefit results from a residue that remains on the leaves following treatment which is essentially the silica of the diatomite. Destructive pests, such as bugs, when eating the leaves will also consume the silica residue. The residue kills the bugs to further enhance the health of the foliage.

The invention is described in more detail in the following description having reference to the accompanying drawings.

### DESCRIPTION OF THE DRAWINGS

FIG. 1 illustrates in diagram form a method of producing a foliar fertilizer of the present invention.

### DESCRIPTION OF THE PREFERRED EMBODIMENT

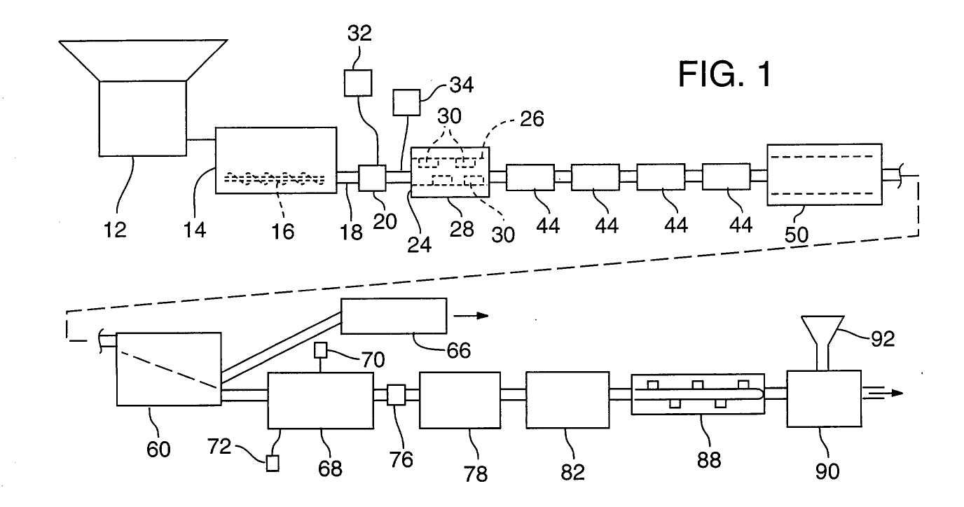

FIG. 1 illustrates in diagram form a process utilized to generate a foliar fertilizer of the present invention. In this embodiment, fish and fish offal are processed to produce the foliar fertilizer of the present invention.

Raw fish and fish offal pass through a mulling stage wherein the fish and fish offal are first reduced to a ground condition by an apparatus such as a grinder 12. The grinder 12 converts the fish and fish offal into a ground condition or suspension. The grinder 12 reduces not only the proteinaceous components of the fish parts to a ground condition but also any other bones, scales and other parts associated therewith. As used herein, a ground condition is a particulate form wherein each particle has a diameter within a range of about 1/16 to ½ inch. Preferably the particles have a mean diametral range of about ¼ inch.

The ground suspension of fish and fish offal most often has sufficient liquid such that dilution or addition of water is not required. It will be appreciated that in some instances water may be added to obtain the desired consistency of the ground suspension.

After grinding, the ground fish is passed from the grinder 12 into a transfer bin 14. The transfer bin 14 tends to even out the flow of the material passing through the grinder. The transfer bin 14 has an internal auger 16 which transports the ground suspension to an inlet of a positive displacement pump 20. The displacement pump 20 is a controllable pump and may be controlled to propel the ground material into the inlet of a heat exchanger 24 at a desired constant flow rate. The flow rate through the heat exchanger is governed by presetting and accurately controlling the pumping rate of the displacement pump 20.

Extraneous enzymes are added to the ground suspension just before the ground suspension enters the heat exchanger 24. This is to insure that the suspension is subjected to a mixing action by the pump 20 and within the heat exchanger 24 which aids in the disbursal of the enzymes throughout the suspension. The extraneous enzymes are preferably of a type known as proteolytic or peptide-hydrolyzing enzymes. Proteolytic enzymes cleave the large ground animal parts into smaller molecules by hydrolyzing peptide bonds along the protein backbone. A commercially available preparation is CARELESS L10.

It has been found that the amount of this preparation required is about 300-400 ml per 1,000 lbs. of raw fish with the poundage of the raw fish being determined prior to the grinding operation. Preferably the enzymes are added to the suspension using a pump with a controllable flow. In this embodiment, a paristolic pump 34 is utilized to dispense the enzymes into the ground suspension.

Aside from the addition of extraneous proteolytic enzymes as required, it is not necessary at this stage to add any other ingredients to the suspension. For example, no extraneous buffering or pH adjusting is required. The natural pH of the suspension is sufficient and is typically in the range of about 6 to 6.5.

As previously mentioned, the ground suspension of fish and fish offal most often has sufficient liquid dictated by the naturally occurring water in the fish and is at about 75%. Additional water may be added if the suspension is too viscous or if the suspension contains a large amount of solids such as bone. If additional water is required, it is preferably added just after the suspension enters the first pump 20 at the transfer bin 14. A water supply is indicated by 32.

The heat exchanger 24 may be of many types and typically has an inner chamber 26 through which the suspension is passed. The inner chamber 26 is surrounded by an outer chamber 28 through which a hot heat exchange medium is passed. Steam is typically used as a heat exchange medium which allows the use of a smaller heat exchanger. In this embodiment, the heat exchanger 24 has scraping paddles 30 in the inner chamber 26 which are rotated at moderate to high speed to impart a mixing action to the suspension as it passes through the inner chamber 26. The paddles 30 insure even mixing and even heating throughout the suspension without any hot or cold spots. As previously mentioned, the positive displacement pump 20 is accurately controlled and therefore the ground suspension flows through the heat exchanger 24 at a preset constant flow rate and the transit time through the heat exchanger is accurately known. Accurate flow rate control insures that the suspension is preheated only to the desired temperature whereat digestion will occur.

The ground suspension of fish is preheated in the heat exchanger 24 to a temperature conducive to trigger proteolytic activity of the enzymes. The temperature is typically within a range of 140-150 degrees Fahrenheit. A temperature of about 150 degrees Fahrenheit is optimal for extraneous enzymes such as papain. It has been found that a temperature above 150 degrees Fahrenheit causes both protein denaturation and enzyme deactivation to occur. A temperature below 140 degrees, while not necessarily disadvantageous, will necessitate a longer time to achieve a desired degree of protein hydrolysis.

After exiting the heat exchanger 24, the ground suspension in the preheated state enters the first digester 44. In this embodiment, multiple small digesters are coupled in series such that the ground suspension passes through each digester in a plug flow condition. That is, a cross sectional volume of material flows linearly along the digester at the same rate. The use of multiple small digesters reduces the possibility of clogging of the digesters by solids in the suspension. The plug flow of the ground suspension through the digesters provides better control of the digestive process thereby insuring maximum nutritive value and resistance to oxidation of the product. Plug flow of the suspension through the digesters also provides for a more rapid digestion process. Another key benefit of carefully controlling the degree of protein hydrolysis by utilizing the series digesters is that minimal changes are imparted to the amino acids comprising the fish proteins. The low temperature enzymatic digestive process for protein reduces the suspension to a predetermined molecular weight. The target value for the number average molecular weight is about 15,000 daltons. In this embodiment, each digester has a volumetric capacity such that a volume of suspension passes through a digester in about 30 minutes.

When the ground suspension passes through the last digester, the ground suspension is heated to about 175-200 degrees Fahrenheit by another heat exchanger 50 to deactivate the enzymes to thus stop further hydrolysis of the protein. The heating of the ground suspension stops the hydrolysis of the ground suspension but does not cause denaturation of the partially hydrolyzed proteins.

After heating the aqueous suspension to the temperature of about 175-200 degrees Fahrenheit, the suspension is transferred to a screening device such as an inclined vibrating screen 60. Passage of the suspension through the screening device removes solids from the suspension. The solids are transferred from the screening device 60 to a receptacle 66. The non-digestible solids may be dried and further processed into bone meal and other similar products.

The aqueous suspension flows to a receptacle 68 where oil is added at a controlled flow rate to form a protein-oil suspension which can be subjected to water removal steps without forming an agglomerated mass that is impossible to pump. The oil is added by a dispenser 70. Phosphoric acid (as P205) is also added as a means of pH control. A positive displacement pump 72 is used to meter an amount of acid sufficient to create a suspension with a pH of approximately 3.5. This prevents spoilage as well as provides a source of phosphorous in the fertilizer. The phosphorous content in the finished product is approximately 2% (w/v).

The protein-oil suspension is then pumped at a controlled flow rate by a pump 76 through a first evaporator 78. The evaporator 78 heats the suspension to about 200 degrees Fahrenheit at about 0 to 15 psig for about 10 to 20 seconds. The suspension is then passed through a second evaporator 82 at sub-atmospheric pressure which completes the desired degree of water removal. The suspension then passes through a pasteurization process indicated at 88.

The suspension flows into a receptacle 90 where diatomite 92 is added as a source of natural minerals as well as a natural pesticide. Diatomite is added in the amount of approximately 5% by weight.

Diatomite (a fine powdered diatomaceous earth) is a sedimentary rock composed mainly of siliceous remains of diatoms which are single celled aquatic organisms that are generally classed as algae. Diatoms develop frustules, or shells, of amorphous opaline silica that commonly are complexly perforated and bear ribs, spines and bristles. Chemical analysis of diatomite typically shows 70 to 90% of S10₂ content as well as approximately 65 to 70 minerals in varying amounts.

The high silica content of the diatomite in combination with oil content of the hydrolyzed product provides the ability to act as a pest deterrent. The oil tends to smother larva and pests in their embryonic stages while the diatomite causes non-mucus forming pests to be cut up internally as they consume the residual diatomite on leaves and branches.

Those skilled in the art will recognize that modifications and variations may be made without departing from the true spirit and scope of the invention. The invention is therefore not to be limited to the embodiments described and illustrated but is to be determined from the appended claims.

1. A foliar treatment product containing nutrients, minerals and pest inhibitors comprising:
in combination, a fertilizer of hydrolyzed fish offal and diatomite suspended therein, said combination provided in liquid form for spraying on foliage.

2. A foliar treatment product as defined in claim 1 wherein the diatomite is at least about 5% by weight of the combination.

3. A foliage treatment product defined in claim 1 wherein hydrolyzation of the fish offal is achieved using enzymes and the mixture heated to the temperature range that is conducive for hydrolic activity of the enzymes without denaturing the protein.

4. A method of producing a foliar treatment product comprising:
(a) producing ground suspension of fish offal;
(b) mixing proteolytic enzymes to the suspension and heating the mixture to a temperature that is conducive for hydrolytic activity of the enzymes without denaturing the protein;
(c) heating the hydrolyzed mixture to deactivate the hydrolytic activity;
(d) removing solids from the mixture; and
(e) dehydrating the mixture and adding diatomite to at least about 5% by weight of the mixture.
